(19) United States
(12) Patent Application Publication
(10) Pub. No.: US 2003/0070159 A1
(43) Pub. Date: Apr. 10, 2003

(54) Object decription language

(75) Inventor: Richard D. Webb, Redwood City, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Intrinsic Graphics, Inc.

(21) Appl. No.: 09/827,197

(22) Filed: Apr. 6, 2001

Related U.S. Application Data
(60) Provisional application No. 60/223,547, filed on Aug. 4, 2000.
(60) Provisional application No. 60/267,433, filed on Feb. 9, 2001.

(51) Int. Cl. G06F 9/44

(52) U.S. Cl. 717/116

(57) ABSTRACT

An object description language and a system in which the language is utilized is provided. The language describes the elements and structure of another programming language. It allows more information to be expressed by a developer than can be expressed in other programming languages. In addition to describing how objects interface with each other, the object description language of the present invention captures thc structure of objects. The object description language can also contain information pertaining to memory management and scheduling. A system in which the language is utilized is also provided. The system assists the developer with code development. The system includes a compiler for the object description language, a compiler for the programming language being described, a separator, and a combiner. The components of the system work together to produce object code that is then executed on an applications platform.

### BACKGROUND OF THE INVENTION

This application claims priority to the provisional application Nos. 60/223,547 and 60/267,433, filed on Aug. 4, 2000 and Feb. 9, 2001, respectively. Both of these applications are incorporated by reference in their entirety herein.

1. Field of the Invention

The present invention relates generally to computer programming languages and more specifically to high-level, object-oriented computer programming languages (used for describing the elements and structure of other programming languages).

2. Related Art

Developers of computer applications need to describe their programs in a simple, straightforward way. Often, more information needs to be expressed by the developer than can be expressed in programming languages such as C++ and Java. For many platforms, the functional structure of programs needs to be expressed to perform optimizations that will take advantage of the features of a given platform.

Although current description languages are becoming more prevalent, they have limitations. For example, Microsoft® COM, an interface description language, primarily describes how objects interface with each other.

COBRA, another interface description language, is also capable of describing only interfaces. The language lacks the ability to describe the actual structure of objects and blocks. Furthermore, COBRA is not extensible. Thus, it only allows developers to specify a fixed set of additional information.

Therefore, what is needed is an object-oriented and descriptive programming language that offers a syntax that is easily extensible (i.e., allows new properties to be added). Furthermore, what is needed is an object-oriented, descriptive and extensible programming language that controls more of the content of the code, thus allowing the code to have greater flexibility.

In addition, what is needed is a system in which such an object description language can be processed in conjunction with the high-level programming language to be described.

### SUMMARY OF THE INVENTION

The present invention is directed to object description languages used for describing the elements of other programming languages, and systems used to effectuate the languages. The Object Description Language (ODL) of the present invention allows developers to describe the structure of their programs in a simple, straightforward manner. The language utilizes its high level description capabilities to realize the program in a way that retains more meta-information (information used to describe objects, such as fields and the type of fields) of the program being described. The result is that the platform on which the programming language of the present invention operates is able to optimize in new ways.

Furthermore, the ODL of the present invention allows developers to perform tasks that would be impractical in other languages. In addition, the ODL of the present invention functions on multiple hardware and software platforms.

The ODL of the present invention allows developers to describe the elements of their programs. The platform on which the language operates can then store the information and use it at run-time. Furthermore, the ODL of the present invention is extensible, and thus allows new elements to be added as necessary.

The system used to effectuate the language of the present invention allows the object description language of the present invention to work in conjunction with a high-level programming language in which the objects are described. For instance, after a code developer writes the object description language code, the code undergoes a special compilation which produces corresponding code in a high-level programming language such as C++.

### BRIEF DESCRIPTION OF THE FIGURES

The following drawings illustrate a system in which the above-referenced ODL operates. The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a diagram of a system that effectuates the ODL of the present invention.

FIG. 2 is a block diagram showing input and output of a module in an example system that effectuates the ODL.

FIG. 3 is a diagram of a header file of an example embodiment of the system that effectuates the ODL.

FIG. 4 is a flowchart representing the general operational flow, according to an example embodiment of a system that effectuates the ODL.

FIG. 5 is a diagram representing two example code segments of the object description language and corresponding C++ language according to an example embodiment of the present invention.

DETAILED DESCRIPTION OF THE PREFERRED EMBODIMENTS
Table of Contents

| | | |
|---|---|---|
| 1. | Object Description Language (ODL) | 5 |

| | | |
|---|---|---|
| A. | ODL Overview | 5 |
| B. | ODL Glossary | 6 |

| | | |
|---|---|---|
| 1. | Object | 6 |
| 2. | Simple Object | 6 |
| 3. | Compound Object | 7 |
| 4. | Child Object | 7 |
| 5. | Parameters | 7 |
| 6. | Namespace | 8 |
| 7. | C++ Abstract | 8 |
| 8. | Volatile | 9 |
| 9. | External | 9 |
| 10. | Inferior | 9 |
| 11. | CCDoc | 9 |
| 12. | Enumeration | 10 |
| 13. | Construct property | 11 |
| 14. | Destruct Property | 11 |
| 15. | Override | 11 |
| 16. | AutoSet | 12 |
| 17. | AutoGet | 12 |
| 18. | Name | 12 |
| 19. | Type | 13 |
| 20. | Version | 13 |
| 21. | Accessibility | 13 |
| 22. | Object Element | 14 |
| 23. | Interface | 14 |
| 24. | Base | 14 |
| 25. | Field | 14 |
| 26. | Persistent | 15 |
| 27. | Connection | 15 |
| 28. | Extension | 15 |
| 29. | Series | 15 |
| 30. | Block | 16 |

| | | |
|---|---|---|
| C. | General Syntax | 16 |
| D. | Object References | 16 |
| E. | Type Specifier | 17 |
| F. | Object References | 18 |

| | | |
|---|---|---|
| II. | System in which the ODL is utilized | 18 |

I. Object Description Language (ODL)

A. ODL Overview

The ODL of the present invention allows developers to describe their programs in a simple, straightforward manner. This high level description can be used to realize the program in a way that achieves a higher performance than mainstream languages. ODL can function on multiple hardware and software platforms.

The ODL of the present invention is extensible. Thus, although the underlying platform can store information used to describe a particular program and use it at run-time, description of new elements can be added as necessary. The code of ODL is centrally generated, and thus infrastructure bug fixes and enhancements can occur in a single place. Furthermore, field storage and parameter passing mechanisms can be altered.

Libraries, applications, and the objects contained within them can be expressed in the ODL. The state information in the objects can be abstractly expressed so that memory and data transfer can be managed using methods that are tuned for a particular platform. In addition, information can be provided through the ODL to enable other standard optimizations that are well known to one skilled in the pertinent art.

The ODL, in an embodiment described herein, uses the syntax of the Scheme programming language because it can describe arbitrarily complex structures in a straight-forward manner, is easily extended with new semantics, is readable by humans, and is easily and quickly parsed by a computer. In addition, the language is supported by most text editors. In one embodiment, the ODL is described by the Syntax BNF supported by the Scheme programming language. See The Scheme Programming Language, by R. Kent Dybvig.

It should, of course, be noted that while the present invention has been described in reference to illustrative embodiments, other arrangements may be apparent to those of ordinary skill in the art. For example, instead of using the above-described system with C++, another object-oriented programming language could be substituted.

B. ODL Glossary

This section describes the various entities, elements and operators of the Object Description Language.

1. Object

An entity that contains state information, which is comprised of encapsulated fields of different types. Depending on the types of fields an object contains, it can be connected to other objects, flow between objects in a dataflow program, or be manipulated by a procedural program written in a high-level computer programming language such as C or C++.

2. Simple Object

An ODL simple object is an object that contains a type and is generated as a C++ using or typedef directive, or as a class or namespace global. The object does not contain any fields. If the object has a value, a class or namespace global is generated (depending on whether its parent is generated as a class or namespace). If the object has the same name as its type object, a using directive is used. Otherwise, a typedef directive is used.

3. Compound Object

An ODL compound object is an object that cannot have a type specifier.

It contains a non-zero number of fields and/or a base object. It is generated as a C++ class. It cannot have a type specifier. It may or may not have child objects.

4. Child Object

A child object is an object within an object, in a hierarchically structured manner. Such a hierarchical structure is illustrated below:

(Object bar

(object hey . . .)
(object you . . .)
(enum Result . . .)

)

5. Parameters

A parameterized object is one that contains a set of formal parameters that appear within the definition of the object. It is analogous to a C++ template.

(object Pair

(Parameters type1 type2)
[field object1 (type type1)]
[field object2 (type type2)]

)

6. Namespace

Some ODL objects exist for the purpose of name space only. Namespace objects should be marked with the namespace property. This is illustrated by the following example:

(object MyUtilities (namespace) . . . )

Namespace is used in conjunction with child objects (discussed, Supra). To prevent ambiguity between object names, child objects are created. When the child objects are referred to within their parent objects, no ambiguity exists because they are referenced within their namespace. To refer to the object outside of its namespace, it must be first prefaced by the name of its parent object.

For example, assume there are two objects by the name of “Matrix.” If one attempts to reference the object by its name “Matrix”, ambiguity results because it is not known to which “Matrix” one intended to refer. To solve this problem, each of the objects is placed within a parent object.

In the above example, an object by the name of “Company A” could be created, and an object by the name of “Company B” could be created. Within each of these objects, a “Matrix” object would exist. As long as the child object, “Matrix”, is referenced within its namespace, no ambiguity results. If the child object is referenced outside of its namespace, it must be first preferenced by the name of its parent (i.e., Company A.Matrix or Company B.Matrix).

7. C++ Abstract

The C++ abstract property is used to indicate that an auto-generated C++ class is an abstract base class. In the following example, an auto-generated C++ class is designated as an abstract base class:

(object foo(c++Abstract) . . . )

8. Volatile

The volatile property is used to mark an object that is code-generated using normal C++ fields, rather than fields enabled for multi-buffering. In the following example, an object is marked with the volatile property:

(object GraphicsContext (Volatile) . . . )

9. External

The external property is used to mark an object that is code- generated by hand. This is illustrated by the following example:

(Object igObject (External) . . . )

10. Inferior

The inferior property is used to designate an object that has no Alchemy meta-information associated with it. This is illustrated by the following example:

(object igMemory (Inferior) . . . )

11. CCDoc

The ccdoc operator is used to add documentation to an ODL object. In he following example, documentation is added to an object:

(object Hello World

(ccdoc “This object prints out\“Hello World\”.”) . . . )

12. Enumeration

An enumeration is a special ODL object that is equivalent to zero or more simple ODL objects. If an enumeration has a name, a simple ODL object is created with the same name, and can be used as a type. Each enumeration word in the names list is a simple ODL object of the type of the enum. In the following examples, use of enumerations are demonstrated:

(enum(names a b c))

(cnum Result (names kSuccess kFailure))

(enum Mode (names

(kRead

kWrite))

The enum type and values can be referenced from other ODL objects and fields, as in the following examples:

(enum FileMode2 (names

(kFileRead (odlRef kRead))
(kFileWrite (odlRef k Write))
kFileAppend

))
(object Myresult (type (odlRef Result)))
(object Foo

[field result

(type (odlRef Result))
(value (odlRefkSuccess))]

)

13. Construct Property

A construct property is a property of a field having a compound object type. If the construct property is set, the field is automatically constructed when the object in which the field resides is constructed. In the following example, field x is automatically constructed whenever the object in which it resides is constructed:

[field x (type (odlRef Foo)) (construct)]

14. Destruct Property

A destruct property is a property of a field having a compound object type. If the destruct property is set, the field is automatically destructed when the object in which the field resides is destructed. In the following example, field x is automatically destructed whenever the object in which it resides is destructed:

[field x (type (odlRef Foo)) (destruct)]

15. Override

An override property is used to alter the default value of a field that inherits a value from an object in which it resides. Any of the properties of a base object's field can be overridden by using the override property. In the following example, field f, which is defined in object Base, is overridden with a new value of 3 in the derived object Sub:

(Object Base

[field f (type igInt) (value 1)]

)

(Object Sub
(base (type (odlRef Base)))
[field f (value 3) (override)]
)

16. AutoSet

The AutoSet function is used to generate set functions. If a name is specified, the corresponding function name will take the form setName. If no name is specified, the function name is computed from the field name. In the following example, the generation of a set function is illustrated:

[field readMode (type igBool) (autoSet)]

[field gMode (type igBool)

(autoSet graphicsMode)

17. AutoGet

The AutoGet function is used to generate get functions. If a name is specified, the corresponding function name will take the form getName. If no name is specified, the function name is computed from the field name. In the following example, the generation of get functions is illustrated:

[field readMode (type igBool) (autoGet) ]

[field gMode (type igBool)

(autoGet graphicsMode)

18. Name

A name is used to identify both compound objects and simple objects. The name of an object can be specified as a normal property (as in the first example below) or as the first parameter of an object (as in the second example):

(object . . . (name foo) . . . )

(object foo . . . )

19. Type

There is a finite set of built-in data types from which all objects are built. Alternatively, an object definition can be a type.

20. Version

An object's version is a number used to identify the particular version of the object. An object may have both major and minor version numbers. Both version numbers may be specified, or only the major version number may be specified. Major and minor version numbers are defined as follows:

If there is a major change to an object that would result in the object now being incompatible with objects with which it was previously compatible, the object is given a new major version number. However, if there is a minor change to an object that does not result in the object being incompatible with objects with which it was previously compatible, the object is given a new minor version number.

21. Accessibility

Accessibility of a field determines whether the field is accessible to a client of its object. Accessibility can be defined as public, private, or protected. Default accessibility is private. “Private” differs from “protected” in that a “protected” field can be accessed only by subclasses. A “private” field is not accessible. The following example illustrates how a field is defined to be of the type public:

[field x (type igInt) (public)]

22. Object Element

An object element is an entity that is part of an object. An object element typically has a name and holds state information of a certain type. The different kinds of elements are described below.

23. Interface

An interface element is an element used for input or output of data into or out of an object.

24. Base

An ODL object with a base ODL object acquires all the properties of the object from which it originates. The following example illustrates how this is accomplished.

(object FileInputStream

(base (type (odlRef InputStream)))

)

25. Field

A field is an element inside of a compound object that holds state information.

26. Persistent

When an object's persistent property is false, all of its fields are forced to be non-persistent. A non-persistent field is not written or read when the object is written or read. Usually, an object's persistent property is set to false when fields are cached values and can thus be recomputed after the object is read in

27. Connection

An element that serves as the conduit for the transfer of data between two objects. Their purpose is to establish fixed points for extensions to which they connect. A connection links a source of data (a field or an object output) to a consumer of data (an object input). They are typically used inside objects that can be used as bases.

28. Extension

An element that defines an object to be added. The object acquires all the elements of the extension object and hooks its connections to the existing connector (place at which a connection is made to allow modular extensions of a program).

29. Series

A special kind of connection that interacts with a connector in such a manner as to allow the data that flows through the connector to be processed in multiple, independent ways.

30. Block

An object that has at least one input and/or output element, and thus can be connected to other blocks in a dataflow program. A block that contains only an evaluate function is referred to as a “simple block.” All others are called “compound blocks” because they are internally comprised of other blocks.

C. General Syntax

All ODL keywords are case-insensitive. Thus, the keyword “field” will be interpreted to be the same as “FIELD.” However, object names may be case-sensitive due to the fact that some high-level programming languages (such as C and C++) are case sensitive. Thus, the example object name “myobj” may not reference the same object as that of “MYOBJ.”

Scheme-style comments are supported. A comment consists of all characters between a semicolon and the following carriage return.

D. Object References

There are two types of object references: a limited (normal) object reference (ObjectRef) and a complete object reference (ObjectCRef).

The ObjectRef operator allows an object definition to reference another object definition. Only the public elements of the referenced object can be accessed. The parameters to ObjectRef may include any number of the properties of the referenced object. The ObjectRef operator resolves the reference and replaces itself with the object definition identified by the parameters. The following example references an object named “iAdder:”

(ObjectRef (Block (Name ‘iAdder)))

The ObjectCRef operator works in the same manner as the ObjectRef operator except that it allows access to all elements of the referenced object, both public and private elements. This operator is normally only used with basis and extension elements.

E. Type Specifier

An object type specifier can specify either a built-in type, or an object definition. Built-in types are supported for building complex objects. A built-in type is specified using the Type operator. For instance, a built-in type may be specified by the following:

(Type {igBol|igInt|igFloat|igPointer})

For all other object types, the object definition is specified. Since most object definitions are defined in one place and referenced by their identifiers, the ObjectRef operator is usually used. However, if an object definition is used in only one place, it can appear “inline” (i.e., the entire body of the object may be used directly). A type specifier can state that the data exists either locally or remotely. A local object is one that is instantiated locally. A remote object is one that exists at another place (inside another object, for instance) and is referenced. The following example illustrates how an object named “Bar” is specified to be of type “igInt:”

(object Bar (type igInt))

Objects having non-built-in types are specified using the definition of the object. Thus, the ObjectRef operator may be used. For example, the following example illustrates how an object named “Bar2” is specified to be of the non built-in type “iAdder” using the ObjectRef operator:

(object Bar2 (type(ObjectRef(Block(Name ‘iAdder)))))

F. Object References

A package can either be a library or an application. The keyword “library” is used to denote libraries, and the keyword “application” is used to denote applications. The package ODL code must be the only top-level ODL element in the file, and there must be only one. For instance, you cannot define two ODL packages in the same file.

All packages have names. The name of a package is specified as a normal property or as the first parameter of the package. The following example illustrates a package specification in which the name of the package is specified as a normal property:

(library (name MyLib) . . . )

The following example illustrates a package specification in which the name of the package is specified as the first parameter of the package:

(application MyApp . . . )

(application MyApp . . . )

II. System in which the ODL is Utilized

A preferred embodiment of the system in which the present invention operates is now described with reference to the figures where like reference numbers indicate identical or functionally similar elements. The left most digit of each reference number corresponds to the figure in which the reference number is first used. While specific configurations and arrangements are discussed, it should be understood that this is done for illustrative purposes only.

A person skilled in the relevant art will recognize that other configurations and arrangements can be used without departing from the spirit and scope of the invention. It will be apparent to a person skilled in the relevant art that this invention can also be employed in a variety of other applications.

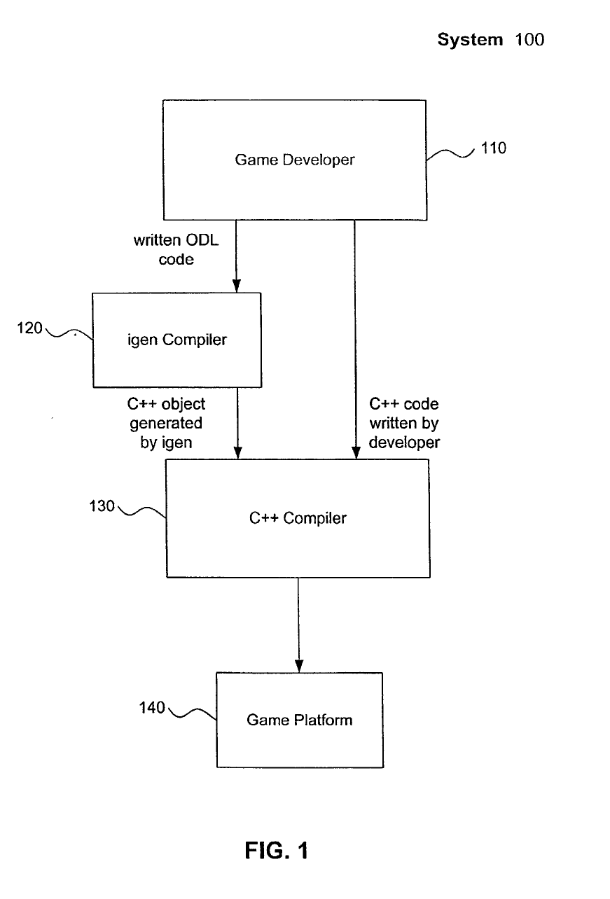

FIG. 1 is a diagram of an example embodiment of system 100, a system in which the ODL of the present invention is utilized. Game developer 110 writes C++ code 135 and ODL code 115. In the embodiment depicted in FIG. 1, ODL code 115 and C++ code 135 may be in separate files. ODL code 115 describes the structure and elements of the computer program written by developer 110. After the developer writes ODI, code 115, code 115 is processed by IGEN compiler 120. IGEN compiler 120 produces code 125, which corresponds to ODL Code 115. In one embodiment, code 125 may be machine code. In another embodiment, Code 125 may be C++ human-readable code. Code 125 then passes to C++ compiler 130.

C++ code 135 is written by game developer 110 and also passes to C++ compiler 130. C++ compiler 130 compiles written C++ code 135 and combines C++ code 135 with Code 125. In one embodiment C++ compiler 130 also compiles code 125 (which is in the form of C++ human-readable code). Finally, object code 137, resulting from the compilation and combination, is executed on game platform 140.

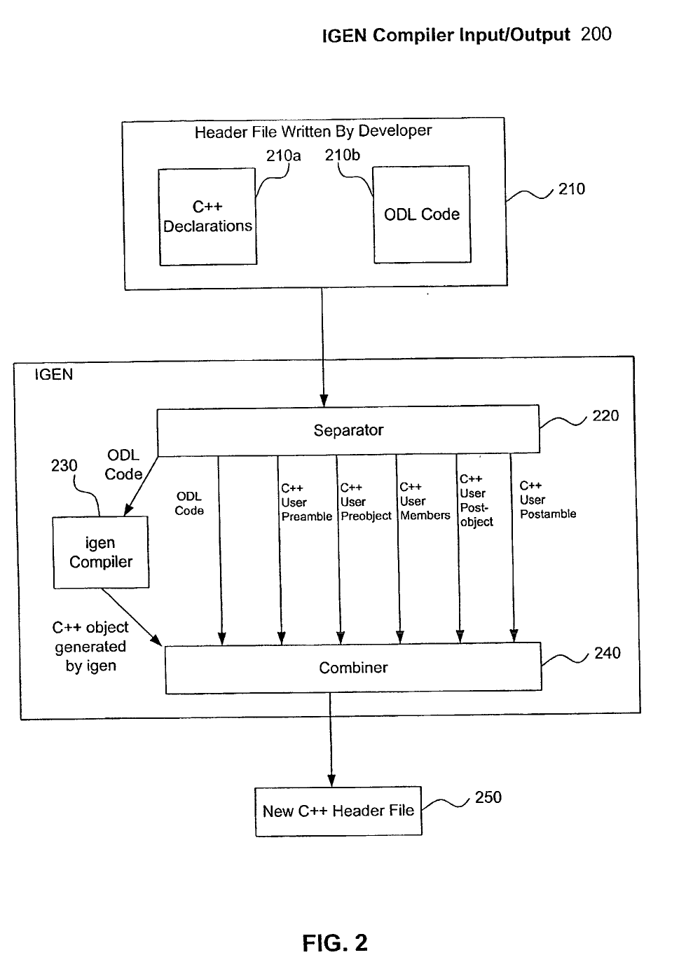

Referring to FIG. 2, an alternative embodiment of the present invention, C++ declarations 210a and ODL code 115 are developed together in a single file. In such a case, ODL code 115 and C++ declarations 210a must be separated, as shown in FIG. 2. Header file 210 is written by game developer 110 and contains C++ declarations 210a and ODL code 115. Header file 210 is passed to IGEN module 215. More specifically, header file 210 is passed to separator 220, located within IGEN module 215. In one embodiment, separator 220, combiner 240, and IGEN compiler 120 may be contained in their own separate modules.

Referring to the example embodiment in FIG. 2, Separator 220 extracts a copy of ODL code 115 from header file 210 written by the developer. Separator 220 then passes a copy of ODL code 115 to IGEN compiler 120. IGEN compiler 120 compiles ODL code 115 and generates code 125. In another embodiment IGEN compiler 120 is actually a translator and translates ODL code 115 into human-readable C++ source code. After the compilation, IGEN compiler 120 passes code 125 to combiner 240. Separator 220 passes the C++ declarations 210a (also represented in FIG. 2 by C++ User Preamble 222, C++ User Preobject 223, C++ User Members 224, C++ User Post-object 225, and C++ User Postamble 226) to Combiner 240.

Combiner 240 combines code 125 with ODL code 115 (written by the developer) and C++ declarations 222-226. The resulting product is a new C++ header file 250. Thus, New C++ header file 250 contains code 125, ODL code 115, and declarations 210a. It should be noted that ODL code 115 is not discarded from the header file. Rather, a copy of ODL code 115 is maintained in the header file 250 as a means of allowing the developer to compare the contents of the header file 210 with the contents of the new header file 250. In another embodiment, ODL code 115 is discarded.

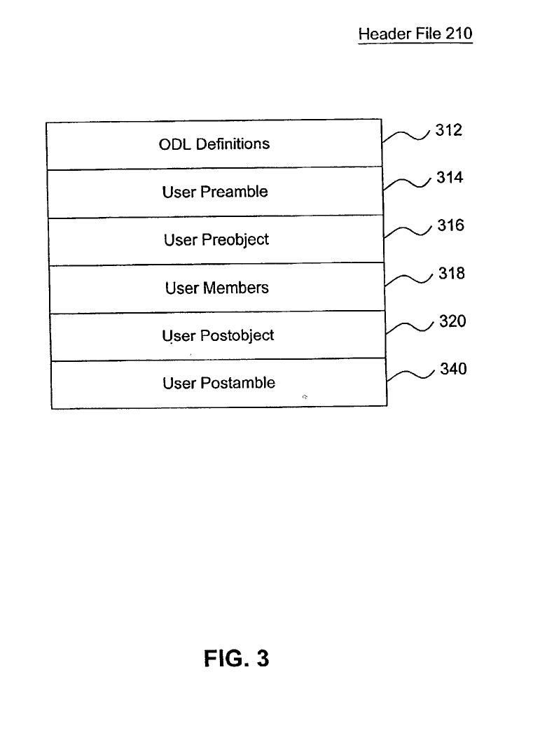

FIG.3 is a diagram of header file 210. Header file 210 contains ODL code 312. ODL code 312 is written by Game developer 110. Header file 210 also contains C++ declaration sections 222-226. C++ declaration sections 222-226 are all user-edited code sections. All user-edited code must reside within these sections. Code inserted outside these sections will disappear during the build process. In another embodiment, if code is inserted outside the sections, an error message will result, and the user will be allowed to rescue the code before header file 210 is overwritten.

Header file 210 contains ODL code 115. All ODL code must reside within ODL definitions section 312. User Preamble section 222 contains high-level programming language code that must precede all other high-level programming language code in the file. For example, if the high-level programming language being used is C++, #include and #define directives would be present in User Preamble section 222. User Preobject section 223 contains high-level programming language code that must reside within the namespace but must precede all class declarations.

Elements of the high-level programming language that are not supported by the ODL are placed in User Members section 224. For example , if the high-level programming language is C++, C++ function declarations would be placed in User Members section 224.

User Postobject section 225 contains high-level programming language code that must reside within the namespace but must be located after all class declarations.

User Postamble section 226 contains all high-level programming language code that must appear after all other high-level programming code in header file 210.

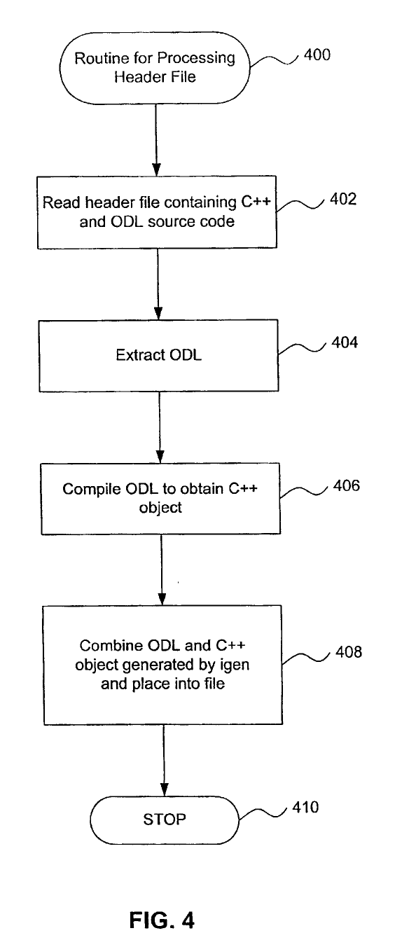

Referring to FIG. 4, a flowchart is shown representing the general operational flow, according to an embodiment of the system in which the present invention is utilized. More specifically, flowchart 400 depicts an example routine for processing header file 210. Routine 400 begins with step 402. In step 402, header file 210, containing C++ declarations 210a and ODL code 115, is read by IGEN module 215. In step 404, separator 220 copies ODL code 115 from header file 210 and passes the copied ODL code 115 to IGEN compiler 120. In step 406, ODL code 115 is compiled to obtain code 125. In step 408, ODL code 125 is combined with C++ code 135 (222-226 in FIG. 2) and ODL code 115, forming a new header file.

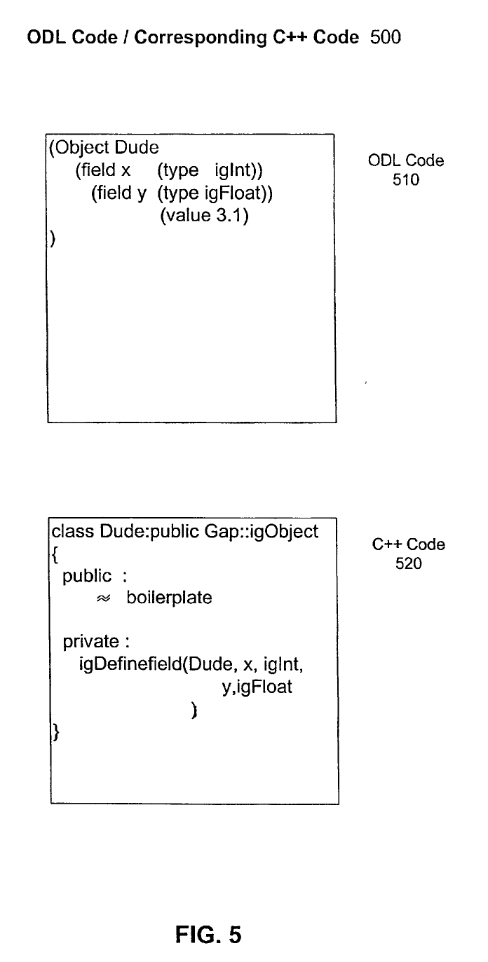

FIG. 5 is a diagram representing two example code segments, ODL code 510 and corresponding C++ code 520 of an embodiment of the present invention. ODL code 510 represents an object definition. The name of the object is “Dude.” Object “Dude” contains two variables, x and y. Variable x is of type igInt, and variable y is of type igFloat and is initially set to the real number 3.1.

Corresponding C++ code 520 is the result of IGEN compilation of ODL code 510. Corresponding C++ code 520 contains a class named “Dude” with public access, and the variables x and y, just as ODL code 510 contains.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. For instance, although the high-level programming language of C++ was used throughout the examples, it should be understood that the present invention may operate in conjunction with other programming languages. Thus, the present invention should not be limited by any of the above-described exemplary embodiments, but should be defined only in accordance with the following claims and their equivalents.

What is claimed is:

1. An extensible, object-oriented, portable programming language that permits centrally defined resource management, wherein an object expressed by the language can be simple or compound, and wherein a simple object comprises the following attributes:
an object name;
an object type;
a version; and
defined accessibility; and
wherein a compound object comprises the following attributes:
an object name;
a base object;
a field;
defined accessibility; and
a persistence property.

2. The programming language of claim 1, wherein said compound object further comprises attributes selected from the group consisting of:
a version,
a child object
a parameter,
a namespace,
a C++ abstract base type,
a volatile property,
an external property,
an inferior property, and
a ccdoc operator.

3. The programming language of claim 1, wherein said simple object can be emulated as an enumeration object.

4. The programming language of claim 1, wherein said field comprises state information.

5. The programming language of claim 4, wherein said state information comprises the following attributes:
a field name;
a field type;
an initial default value;
accessibility;
a construct property;
a destruct property;
an override property;
an automatic set function;
an automatic get function; and
a ccdoc operator.

6. The programming language of claim 1 having a syntax described by the following Syntax BNF:
letter ::=“A”|“B”|. . . |“Z”,
number::=“1”|“2”|. . . |“9”,
atomic_symbol::=letter atom_part,
atom_part::=empty|letter atom_part|number atom_part,
empty::=“”,
S_expression::=atomic_symbol|“(“S_expression “.”S_expression”)”|list,
list::=“(“S_expression # S_expression”)”.

7. The programming language of claim 1 wherein said language can express a nested list that comprises the following atomic elements:
keywords;
names of auto-generated elements; and
literals.

8. The programming language of claim 7, wherein said literals of the nested list are selected from the group consisting of booleans, numbers, and strings.

9. The programming language of claim 7, wherein said auto-generated elements are selected from the group consisting of objects and field names.

10. The programming language of claim 1, wherein said language can express hierarchically structured packages selected from the group consisting of applications and libraries.

11. The programming language of claim 10, wherein said packages can be defined by: (library (name, nameoflibrary . . . ).

12. The programming language of claim 10, wherein said packages can be defined by: (library, nameoflibrary . . . ).

13. The programming language of claim 10, wherein said packages can be defined by: (application (name, nameofapplication) . . . ).

14. The programming language of claim 10 wherein said packages can be defined by: (application, nameofapplication . . . ).

15. The programming language of claim 1, wherein the objects are selected from the group consisting of C++ classes, namespaces, templates, and constant values.

16. The programming language of claim 15, wherein said constant values are selected from the group consisting of enums, class static variables, and namespace-scoped global.

17. A system for describing structure of programming languages, comprising:
(a) a high-level programming language;
(b) an extensible, object-oriented programming language for describing said high-level programming language; and
(c) a programming tool for converting said object-oriented programming language.

18. The system of claim 17, wherein copyright text, CCDoc directives, and compiler pragmas are automatically added to the system.

19. The system of claim 17, wherein input and verification parameters are specified in said extensible and object-oriented descriptive programming language.

20. The system of claim 17, wherein said programming tool is a compiler.

21. The system of claim 17, wherein said programming tool is a translator.

22. A method for describing computer programs by retaining meta-information about program elements, thereby allowing optimization and functionality on multiple hardware and software platforms, comprising the following steps:
(a) creating a first program using a high-level programming language;
(b) creating a second corresponding program using an extensible, object-oriented programming language to describe the high-level source code; and
(c) converting the second corresponding program into a form of the high-level programming language.

23. The method of claim 22, wherein the form is machine-executable.

24. The method of claim 22, wherein the form is high-level programming language.

25. The method of claim 22, wherein results of said step (a) and said step (b) are placed into one file, and further comprising the steps of:
(d) copying said second corresponding program from the file; and
(e) combining said second corresponding program with the form of the high-level source code.

26. The method of claim 25, wherein the file is a header file.

27. The method of claim 26, wherein the header file comprises the following sections:
Definitions;
User Preamble;
User Pre-object;
User Member;
User Postobject; and
User Postamble.
